(19) United States
(12) Patent Application Publication
(10) Pub. No.: US 2013/0185013 A1
(43) Pub. Date: Jul. 18, 2013

(54) METHOD AND DEVICE FOR ASCERTAINING A STATE OF A SENSOR

(71) Applicants: Ulrich WAGNER, Stuttgart (DE); Uwe KONZELMANN, Asperg (DE); Michael RITTMANN, Ditzingen (DE)

(72) Inventors: Ulrich WAGNER, Stuttgart (DE); Uwe KONZELMANN, Asperg (DE); Michael RITTMANN, Ditzingen (DE)

(73) Assignee: Robert Bosch GmbH, Stuttgart (DE)

(21) Appl. No.: 13/743,585

(22) Filed: Jan. 17, 2013

(30) Foreign Application Priority Data
Jan. 17, 2012 (DE) 10 2012 200 592.7

(51) Int. Cl. G01D 18/00; G06F 17/18

(52) U.S. Cl. CPC G01D 18/008; G06F 17/18
USPC 702/104

(57) ABSTRACT

In a method for determining a state of a sensor configured to ascertain an operating parameter of an internal combustion engine, at least one aging effect which has an influence on a sensor characteristic curve of the sensor is detected. The sensor has different sensor characteristic curves for different states of the sensor. The at least one aging effect is detected during operation of the sensor. An item of aging information which reflects the at least one aging effect is stored in an electronic memory. The state of the sensor is deduced from the aging information which is present in stored form and which reflects the aging effect that has acted on the sensor. The deduction is carried out based on a predefined linkage between the at least one aging effect and the state of the sensor.

### BACKGROUND OF THE INVENTION

1. Field of the Invention

The present invention relates to a method for determining a state of a sensor which is configured to ascertain an operating parameter of an internal combustion engine.

2. Description of the Related Art

For operating an internal combustion engine, it is known to use sensors to detect operating states. It is also known that a sensor has a characteristic curve which maps a primary measured variable, such as current or voltage, onto the target variable of the sensor, for example, the temperature for a temperature sensor. This characteristic curve is generally a function of physical properties (material, geometry, etc.) of the sensor. The physical properties are in turn subjected to aging processes which influence, for example, the material and the characteristic curve of the sensor in general. Thus, the sensitivity of a sensor may be reduced or changed in general with increasing operating time or under high thermal load. Distorted measuring results are obtained if the effects of the aging process are not taken into account in the operation of the sensor.

Published international patent application document WO 2006/092223 A1 describes the correction of a drift, i.e., the correction of a change in the characteristic curve of an air mass sensor. To detect the sensor error, the entire system, including an internal combustion engine, is operated at certain setpoint values in order to form a reference. The sensor data that are to be expected for these setpoint values and for a trouble-free sensor are compared to the sensor data actually ascertained. This results in a sensor error which may be used for the correction. The cause of the errors, i.e., the aging, is not addressed in this publication.

A calibration procedure as described above requires operation of the entire system, including the internal combustion engine, at a certain setpoint operating point as a reference which is to be specifically set. On the one hand, deviations in the setting of the setpoint operating point of the internal combustion engine result in errors which are not detected by the calibration and which result in systematic distortion. On the other hand, the described calibration process is laborious, since the internal combustion engine must be operated at a setpoint operating point, even if the user of the internal combustion engine momentarily desires a different operating point.

An object of the present invention, therefore, is to provide a procedure via which changes in the behavior of sensors due to aging may be precisely and easily determined.

### BRIEF SUMMARY OF THE INVENTION

The present invention allows aging processes to be easily detected. In particular, intervention into running systems is not necessary. Components which are inexpensive and for the most part already present may be used to implement the present invention. In addition, there is less complexity of circuitry, and no fundamental changes are necessary in systems which are already known. Devices according to the present invention may be used without modifying the environment in which the devices are used. The data necessary for carrying out the present invention are usually already present, so that no complicated additional detection mechanisms are necessary.

According to the present invention, data which are already present concerning aging effects may be ascertained, for example by simple transmission, and converted into instantaneous sensor properties via linkages which are easy to establish. These data may be easily used for compensation, resulting in precise measuring results despite aging processes of the sensor. In particular, a separate reference measurement, for example by operating at a setpoint operating point, is not necessary, so that carrying out the method does not change the handling of an internal combustion engine.

The underlying concept of the present invention is to detect aging effects, on the basis of which the instantaneous state of the sensor is deduced. In particular, the instantaneous characteristic curve is deduced, which due to the detected aging effects may be different from a new or standard state of the sensor. On the one hand, it may thus be deduced whether the sensor already has a lower level of precision due to aging, or on the other hand, the changed behavior of the sensor due to aging may be estimated based on the detected aging effects. The last-mentioned option allows the measurements to be corrected according to the changed sensor characteristic curve, and the first-mentioned option allows a sensor altered by aging to be recognized without a reference or calibration measurement. The linkage between an aging effect and behavior changed by aging, in particular the characteristic curve changed by aging, may be easily obtained. The linkage between an aging effect and a changed behavior or state of the sensor results in a simple manner from empirical models or from models which approximate the aging process.

Therefore, a method for ascertaining a state of a sensor is provided, the sensor being set up to ascertain an operating parameter of an internal combustion engine. An internal combustion engine is in particular considered to be the internal combustion engine of a motor vehicle, whereby not only the internal combustion engine itself, but also the exhaust system and the fuel supply, air supply, and coolant supply thereof are regarded as part of the internal combustion engine.

The sensor is operated to ascertain the operating parameter, in particular in an active or in a passive mode. Over time, aging results from operation of the sensor.

The sensor detects a physical operating variable of the internal combustion engine, such as a flow rate. The sensor is used to initially detect a sensor measured variable, for example a voltage or a voltage difference, during operation.

This sensor measured variable may be regarded as a primary measured variable which depends on the measuring principle of the sensor. The sensor measured variable is usually an electrical variable such as a current, a voltage, or an impedance (in particular a resistance) as an absolute variable or as a differential variable, such as a voltage difference at resistors. The sensor measured variable is output by the sensor as a sensor output signal, for example a digital signal. The sensor output signal reflects the sensor measured variable. The operating variable to be detected is output as the target variable of the measuring process.

According to the present invention, at least one aging effect is detected. This aging effect has an influence on a sensor characteristic curve of the sensor. The sensor characteristic curve indicates the dependency of a target variable to be detected, for example a flow rate, on the primary measured variable. The primary measured variable is the sensor measured variable, for example a voltage difference or resistance difference. The sensor characteristic curve is linked to the sensor, and is subject to the aging effect.

The sensor has different sensor characteristic curves for different states of the sensor. The different states are thus distinguished with respect to the aging, which in turn influences the sensor characteristic curve. In particular, the aging state of the sensor is regarded as the state of the sensor. According to the present invention, the at least one aging effect is detected during operation of the sensor. The aging which results from operation of the sensor is thus recorded by detecting the aging effect. In particular, this type of detection is based on a measurement of variables which influence the aging of the sensor, for example the temperature. The aging effect may be detected based on variables which are measured anyway during operation of the internal combustion engine or ascertained in some other way, or the aging effect may concern variables which are detected specifically for determining the aging. Numerous variables which influence the aging are already present during operation of the internal combustion engine, or may be easily deduced from such variables, for example, based on the number of switch-on operations of the sensor and/or of the internal combustion engine. The aging effect is thus measured, or deduced from measurements of variables which influence the aging. “Aging” refers to aging-related changes of a physical-electrical converter element of the sensor itself, to evaluation components of the sensor which process or condition the primary measured variable, and to fluid mechanical or mechanical components of the sensor, such as feed lines.

The aging effect is stored. In particular, aging information which reflects at least one aging effect is stored. The aging information may be provided in particular by values which reflect the variables which influence aging. The aging information is stored in an electronic memory, in particular in a semiconductor memory. The semiconductor memory may in particular be a memory within a microprocessor which is used to evaluate the sensor data. In addition, this may be a memory which is connected to this type of microprocessor.

The state of the sensor is deduced from the aging information that is present in stored form, in particular from the aging information that is stored in the electronic memory during the above-mentioned step. The aging information reflects the aging effect that has acted on the sensor. The aging information in particular reflects the aging effect that has acted on the sensor since manufacture or installation. In particular, the aging information may be reset, for example during calibration or maintenance of the sensor, so that the aging information reflects the aging effect that has acted on the sensor since the most recent reset. The state of the sensor is deduced based on a predefined linkage between the aging effect and the state of the sensor. The predefined linkage reflects to what extent the aging effect has an influence on the state of the sensor, and in particular, on the sensor characteristic curve of the sensor. On the one hand, the aging information itself may be regarded as the state of the sensor, since, for example, the number of switch-off operations or the operating time reflects the operating age of the sensor, and thus, also its state. In this case, the predefined linkage corresponds to a direct correspondence or an identity, since the state is directly reflected by the aging information.

In addition, the state may reflect the sensor behavior, in particular the sensitivity of the sensor or the characteristic curve in general. In this case, the linkage forms a relationship between the aging information and the function of the sensor, i.e., the manner in which the sensor converts the operating variable into the sensor measured variable or into the sensor output signal. The characteristic curve may be a function of additional parameters. The predefined linkage is described in greater detail below.

One preferred specific embodiment provides that the predefined linkage between the aging effect and the state of the sensor is present in the sensor or in a control unit which is connected to the sensor. The sensor or the control unit connected thereto thus forms a unit with the linkage.

Mix-ups in deducing the state of the sensor are thus prevented, and the predefined linkage between the aging effect and the state that is typical for the specific sensor may be directly employed by using the sensor or the control unit connected thereto.

The linkage is present in the form of an approximation formula, in the form of a model, in the form of empirical data concerning sensor states as a function of aging effects, or in the form of a look-up table. These approximately reflect how the behavior of the sensor changes as a function of the aging effect. In particular, the look-up table lists various aging effects of different sensor states, for example based on aging effects which are measured or estimated based on physical models, and associated sensor states. The aging effects are present in the form of the aging information.

In one preferred specific embodiment, the linkage is present as an approximation formula, whereby the approximation formula may be a proportional or linear approximation formula, for example. In principle, the approximation formula may be an approximation formula of the first, second, or higher order. The approximation formula may in particular be present in the form of parameters which define the associated approximation function, for example in the form of two parameters which reflect a linear linkage. The state of the sensor may be provided in degrees of aging, or in particular in the form of characteristic curves or numerical information relating to the characteristic curve, for example a drift, a (reduced) sensitivity, or a factor by which the sensitivity is reduced with respect to a standard state of the sensor.

Another specific embodiment of the present invention provides that a sensor characteristic curve is stored in the sensor or in a control unit connected thereto. This sensor characteristic curve corresponds to the predefined linkage of the aging information. The aging information is present in stored form, as mentioned above. Alternatively, a characteristic curve correction may be stored in the sensor or in the control unit. The characteristic curve correction represents a correction of the sensor characteristic curve. The characteristic curve correction reflects the difference between a standard sensor characteristic curve and a sensor characteristic curve which the sensor has according to the aging information and the linkage which are present in stored form. The standard sensor characteristic curve reflects a characteristic curve of an unaged sensor, or of a sensor which has been recalibrated or regauged. The standard sensor characteristic curve reflects the behavior of the sensor which is not aged. The standard sensor characteristic curve may be specific to the type, the model, or the particular sensor that is present. In principle, the sensor or the control unit connected thereto may store the instantaneous behavior of the sensor which may possibly be changed by aging, or may store a difference from a standard behavior of the sensor, the standard behavior relating to an unaged sensor or a calibrated or gauged sensor, and the difference reflecting the change due to the at least one aging effect. Thus, the absolute behavior caused by aging may be stored, or merely the change with respect to a standard behavior may be stored, taking only the change in the aging into account. The information concerning the sensor behavior, i.e., the sensor characteristic curve or the characteristic curve correction, is preferably stored in the above-mentioned electronic memory or in some other electronic memory. The information in question may be stored in the form of individual values, for example interpolation points of a characteristic curve or of a characteristic curve correction, or parameters which define a function which approximates the characteristic curve or the characteristic curve correction. The standard behavior corresponds, for example, to the standard sensor characteristic curve or to the standard state as it is defined.

In particular, it is provided that at least one sensor measured value is ascertained during operation of the sensor. The sensor measured value reflects the sensor measured variable. The sensor measured value is converted into the operating parameter to be ascertained, based on the sensor characteristic curve or based on the standard sensor characteristic curve which is corrected by the characteristic curve correction. The operating parameter is output, for example, by retrievably storing it. The sensor measured value forms the primary measured variable of the sensor, and is provided as an electrical signal, for example. In contrast, the operating parameter forms the physical variable (target variable), to be detected with the aid of the sensor, which is linked to the sensor measured variable. In the case of a hot film air mass meter, for example, the sensor measured value results from the difference between two resistances or voltages which are recorded by two temperature sensors, while the operating parameter corresponds to the flow rate which results from the resistances or voltages of the temperature sensors or from their difference. In particular, the sensor measured variable is a voltage difference between resistors.

In the examples mentioned above, the aging information is used to determine or reuse the behavior of the sensor itself, based on the aging information. The behavior of the sensor is the mapping of the sensor measured variable (for example, the resistance or voltage, or another sensor signal) onto the target variable which is detected by the sensor, for example a flow rate.

In the following alternative specific embodiment, the state reflects the degree of aging by which the sensor has aged. In other words, the reliability, or a measure of susceptibility to error due to aging, for example, is referred to as the state of the sensor. This state does not correspond to the mapping of a primary measured variable onto a target variable to be detected, for example the conversion carried out by the sensor, but, rather, relates to the aging state of the sensor itself.

According to the present invention, the state is deduced by querying the aging information that is present in stored form. The aging information is statistically analyzed. The result of the statistical analysis defines the state of the sensor. For example, the aging information that is present in stored form may reflect the number of switch-on operations of the sensor. The magnitude of this number directly defines the state of the sensor; for example, a large number of switch-on operations corresponds to a greatly aged sensor, and a small number of switch-on operations corresponds to slight aging of the sensor. Instead of the number of switch-on operations, the operating time may be used in the same sense, or also the duration of operation at a temperature which is above a predefined maximum operating temperature. In this specific embodiment, the state does not directly correspond to the converter properties of the sensor, but, rather, to the degree of aging of the sensor.

Another option is to store the aging effect, and thus the aging information, in the sensor or in a control unit connected to the sensor. The aging effect or the aging information is preferably stored in electrical form, in particular in the form of a value in binary notation. The aging information is thus directly linked to the affected sensor. In other words, the operation, and thus the aging which is thus linked, is recorded in the sensor, whose aging is reflected by the aging information. The aging effect of the sensor thus reflects the aging of the sensor itself in which the aging information is stored. If the aging information is stored in the control unit, the aging information in question reflects the aging of the sensor which is connected to the control unit. The sensor or its control unit thus carries the aging information of the aged sensor in question.

The sensor operated according to the method is preferably a flow rate sensor, in particular a hot film air mass meter. Alternatively, the sensor is operated as a force sensor, torque sensor, or pressure sensor. In addition, the sensor operated according to the method may be an ultrasonic sensor. In particular, relevant aging takes place in these sensors, the aging having a direct influence on the sensor properties. The aging has a direct influence, for example, on a drift, or on a changed and in particular reduced sensitivity, or on a factor by which the sensitivity is changed and in particular reduced with respect to a standard state of the sensor. The sensor operated according to the method may in particular also be an optical sensor, for example a brightness sensor, which has a reduced sensitivity to brightness due to aging-related contamination or due to continual exposure to brightness.

The at least one aging effect may be automatically detected. The aging effect may in particular be detected by signals which are present at the sensor itself or present at a control unit which is connected to the sensor. These types of signals are the operating state (sensor on/off), for example, or the temperature or intensity or duration of a vibration, for example. Based on the operating state (sensor on/off), it is possible to detect how often the sensor is switched on or off. The number of switch-on operations or switch-off operations of the sensor may thus be easily ascertained. This number forms the aging effect according to the present invention, and may be stored as aging information as described. Likewise, the operating time may be easily detected, for example with the aid of a timer and based on the operating state of the sensor. The sensor itself may emit additional sensor signals, for example an instantaneous operating temperature. These additional signals which are also detected by the sensor may likewise be evaluated as an aging effect. One specific embodiment of the present invention provides that a number of switch-on operations of the sensor (or switch-off operations of the sensor), an operating time of the sensor, a maximum operating temperature of the sensor, a temperature profile of the sensor, an operating time of the sensor above an upper temperature limit, and/or an intensity of a vibration is/are detected as an aging effect with the aid of a detection device. This detection device may, as described, be a mere tapping of a signal, which is already present, of the control unit or of the sensor. The detection device may also be an additional sensor unit that is mounted inside the sensor, a temperature sensor, for example, or may be an additional sensor that is set up to ascertain aging effects of the sensor, the state of which is ascertained according to the present invention. An instantaneously detected operating temperature of the sensor which represents the maximum of all temperatures of the sensor is regarded as the maximum operating temperature of the sensor. In addition, an upper temperature limit may be provided which corresponds to the upper temperature limit that is allowed for the sensor. The duration of operation of the sensor above this upper temperature limit or the number of exceedances of the upper temperature limit forms an aging effect according to the present invention which is stored as aging information. In addition, the detected temperature above the upper temperature limit may be weighted, the intensity of the exceedance representing the weighting factor. This weighted measure may be integrated or summed, for example, to obtain weighted information concerning the temperature-related aging, which is stored as aging information. Similarly, the intensity of a vibration may be used as a weighting factor to allow vibrations to be taken into account according to the present invention as an aging effect.

One alternative specific embodiment provides that an input/output interface is provided, via which this type of aging effect is input. This input/output interface is preferably an automatic interface via which signals are automatically processed, for example, an interface which is connected to a tap of a signal, which reflects the tapping influence. Lastly, contamination of the sensor may be taken into account by input, the input/output interface representing a data interface via which data concerning the level of contamination may be externally input. This input may be entered automatically or by a user. In principle, all aging effects in the form of applicable aging information may also be externally input automatically with the aid of a data input interface, or by a user with the aid of an appropriate user input interface, for example the connection to a keyboard.

According to another aspect of the present invention, the stored pieces of aging information may be read out and the sensor characteristic curve may be determined. According to the present invention, the determined, and thus measured, characteristic curve may be correlated with the stored aging information. This may be used to create an approximation formula as described above or a model as described above, in particular in the form of empirical data. The comparison of a measured sensor characteristic curve to the associated aging information may preferably be used to create a look-up table which is used for further sensors, preferably of the same type. Based on these empirically obtained data, the sensor characteristic curves of other sensors may thus be detected based solely on the stored aging information and the above-described empirical data. The detection according to the present invention of the sensor characteristic curve by measurement and the comparison of the sensor characteristic curve thus determined to the aging information in question is used to establish the predefined linkage of the method according to the present invention.

In addition to the above-described methods, according to the present invention a sensor system for ascertaining a state of a sensor is provided which is set up to ascertain an operating parameter of an internal combustion engine. The sensor, the state, and the operating parameter of the sensor system correspond to the sensor, the state, and the operating parameter as used in the method according to the present invention. The sensor system includes the sensor. The sensor has different sensor characteristic curves for different states. The sensor characteristic curves correspond to the sensor characteristic curves used according to the method. The sensor system according to the present invention also includes an electronic memory, in particular the electronic memory used according to the method. The sensor system also includes a data transmission point which is connected to the memory. The sensor system is set up to retrievably store aging information of at least one aging effect in the memory via this data transmission point. The data transmission point forms an interface which is set up to input the aging effect. The data transmission point is in particular designed in the same way as the input/output interface or tap described above with reference to the method. Lastly, the sensor system according to the present invention includes an output which is set up to output the state of the sensor based on the aging information. One preferred specific embodiment of the sensor system according to the present invention includes a predefined linkage between the aging effect and the state of the sensor. This linkage corresponds to the predefined linkage as has been described herein with reference to the method. The predefined linkage is provided in the form of an approximation formula, in the form of a model, in the form of empirical data concerning sensor states as a function of aging effects, or in the form of a look-up table. The look-up table lists various aging effects of different sensor states. The sensor states reflect a property of the sensor which changes as a result of the aging effects.

The linkage is provided in the sensor, the sensor having the above-described output. Alternatively, the linkage is provided in a control unit of the sensor system which is connected to the sensor. The control unit of the sensor system has the above-described output. The predefined linkage is stored in a memory, preferably the memory in which the aging information is also retrievably stored. The memory may be part of a microprocessor that is present in the sensor, or may be part of a microprocessor that is present in the control unit. In addition, the linkage may be provided in a memory which is provided with this type of microprocessor in the sensor or in the control unit.

Another specific embodiment of the present invention provides that a sensor characteristic curve is stored in the sensor or in a control unit, in particular the above-described control unit. This sensor characteristic curve corresponds to the linkage, present in the memory, of the aging information which is present in the memory. The sensor characteristic curve may in particular be stored in the same memory in which the aging information is also present in stored form. Instead of the sensor characteristic curve, a characteristic curve correction may be stored in the sensor or in the control unit. The characteristic curve correction reflects the difference between a standard sensor characteristic curve of an unaged sensor and a sensor characteristic curve which the sensor has according to the aging information and the linkage which are present in stored form The characteristic curve correction thus reflects the difference between the setpoint state and the actual state of the behavior of the sensor, the behavior being depicted as a characteristic curve. The standard sensor characteristic curve forms the setpoint state, and the sensor characteristic curve, which the sensor has according to the aging information and the linkage which are present in stored form, forms the actual state.

The sensor characteristic curve or the characteristic curve correction may be stored in the form of approximation parameters, for example parameters of an approximation formula, for example a linear approximation formula or a second- or higher-order approximation formula. The characteristic curve correction or the sensor characteristic curve may be implemented in the same way as the linkage. The predefined linkage maps the aging information onto the state of the sensor. In comparison, for this purpose the sensor characteristic curve maps a sensor measured variable, for example a resistance or a voltage, onto the target variable, for example a temperature or a flow rate or some other operating parameter, which is ascertained with the aid of the sensor.

In principle, multiple aging effects may be combined, so that the aging information reflects, for example, the number of switch-on operations combined with the operating time of the sensor above an upper temperature limit. The aging information thus reflects multiple aging effects, and in the above-mentioned example reflects the number of switch-on operations and the thermal load.

In one specific embodiment, there is a connection between the sensor and the control unit which transmits multiple operating variables, for example, a flow rate which is detected by a hot film air mass meter, and a temperature of the detected air mass, such as an intake air temperature. One of the operating variables, in particular the air mass flow rate, is detected by the sensor, and the other variable, in particular the temperature, is ascertained, among other purposes, to detect the aging information. The aging information thus obtained is used to ascertain the sensor characteristic curve which results from aging. The first-mentioned operating variable is ascertained based on the sensor characteristic curve which is represented in this way. The first-mentioned operating variable results as a target variable, for example an air mass flow rate, due to a conversion which the sensor carries out. Thus, if multiple operating parameters are ascertained, one of the operating parameters is used to obtain the aging information and to compute an aging-related sensor characteristic curve, another operating parameter (as a target variable) being computed based on the sensor characteristic curve provided in this way.

As an alternative to a control unit, a computing unit may be provided in the sensor itself, which uses the aging information to deduce the state of the sensor and in particular to provide a characteristic curve, on the basis of which the computing unit converts the operating parameter measured in the sensor into a target variable using an aging-adjusted characteristic curve correction according to the present invention.

If the memory according to the present invention is provided in the sensor itself, the sensor preferably includes a special plug adapter having a specific contact via which the state of the sensor or the aging information may be read out.

### BRIEF DESCRIPTION OF THE DRAWINGS

FIG. 1 shows an illustration of sensor characteristic curves for explaining the present invention.

FIG. 2 shows one exemplary embodiment of the sensor system according to the present invention, in a block diagram illustration.

### DETAILED DESCRIPTION OF THE INVENTION

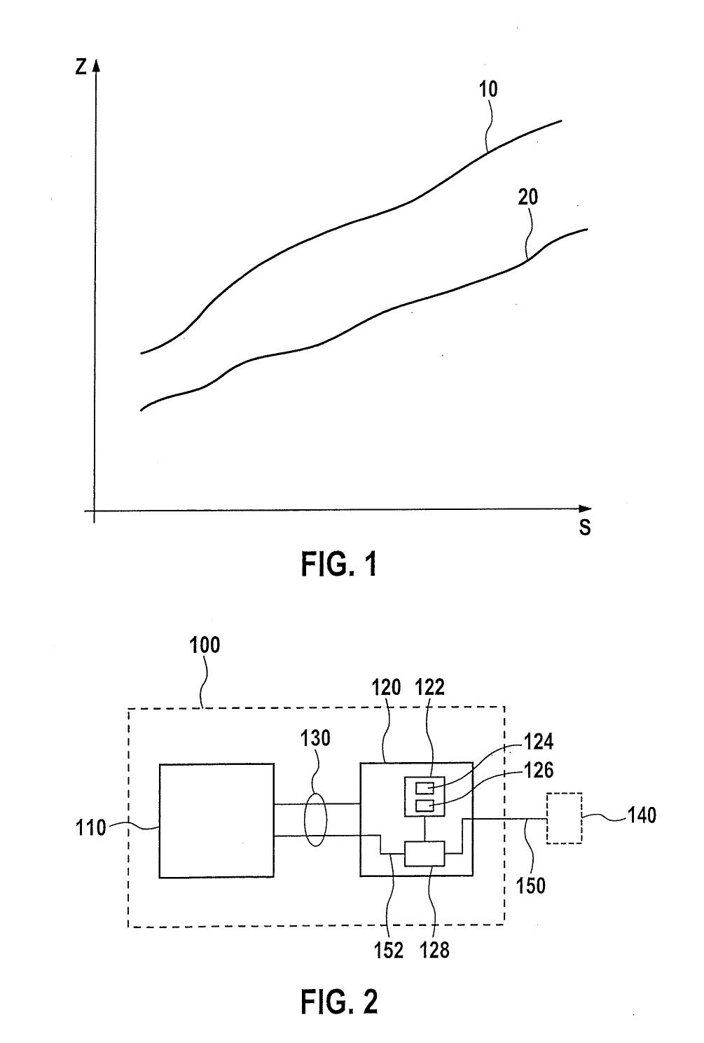

FIG. 1 shows an illustration of sensor characteristic curves for explaining the present invention. The illustrated characteristic curves reflect the relationship between a target variable Z and an associated sensor measured variable S. Sensor measured variable S is provided as an electrical signal, for example as a voltage or a voltage difference. The target variable corresponds to the operating parameter for the ascertainment of which the sensor is set up. Sensor measured variable S is a primary measured variable from which target variable Z is computed. In one example, sensor measured variable S is once again a voltage difference which corresponds to the voltage difference between two adjacently situated temperature sensors. In this example, target variable Z corresponds to a flow rate, the associated sensor being a hot film air mass meter which includes the two adjacently situated temperature sensors. The voltage difference reflects the difference between the temperatures that are present at the temperature sensors. When a constant flow rate is established, a thermal equilibrium results between the sensor diaphragm together with temperature sensors and heaters, and the flow boundary layer. The quantity of the dissipated heat is proportional to the flow rate. The sensor diaphragm is cooled more intensely upstream from the heater, which is regulated to a constant excess temperature, than downstream from the heater, since at that location a portion of the heat is emitted from the flow boundary layer back to the diaphragm. This results in an asymmetrical temperature profile whose shape and characteristic are a function of the flow rate. The differential temperature at the temperature sensors is reflected in the voltage difference, which in turn allows the target variable, i.e., the flow rate, to be directly deduced.

A first characteristic curve 10 corresponds to a standard sensor characteristic curve which relates to a sensor that is essentially unaged, for example a newly manufactured sensor. A sensor characteristic curve of the same sensor which, however, has been subjected to aging effects due to operation is denoted by reference numeral 20. Characteristic curve 20 thus shows an aging-related decrease in the sensitivity, which is apparent from the lower slope, and a drift toward lower values of target variable Z. The lower sensitivity and the differing target values may result from changes within the temperature sensor due to thermal impairment and/or the thermal drift of electrical components connected downstream, and/or geometric distortions in the measuring channel due to altered material properties. With the aid of the present invention, it is possible to ascertain actual sensor characteristic curve 20 based solely on aging effects which are freely accessible and usually already present, and to appropriately correct the actual sensor characteristic curve during the evaluation of the sensor.

FIG. 2 shows one specific embodiment of the sensor system according to the present invention in a block diagram illustration. The proposed sensor system includes a sensor 100 having a sensor element 110, which may be designed as a temperature sensor, for example. Sensor 100 also includes a computing unit 120 which is connected to sensor element 110 inside sensor 100 via a dual-channel connection 130. Dual-channel connection 130 includes a connection for transmitting the operating parameter, for example a mass flow rate, which is detected by the sensor. Connection 130 may form a data transmission point according to the present invention. A second channel of connection 130 transmits an aging effect, in particular the temperature of sensor element 110. The temperature is on the one hand relayed to a control unit 140 connected downstream, and on the other hand is used within sensor 100 as aging information. For this purpose, computing unit 120 includes a memory 122 in which, in addition to the aging information which has been transmitted via connection 130, a predefined linkage 126 is stored, for example in the form of parameters of an approximation formula. Aging information 124 as well as linkage 126 are stored in memory 122. A sensor characteristic curve 128 which is formed according to linkage 126 and aging information 124 is also present in computing unit 120. This sensor characteristic curve is used within computing unit 120 to output the operating parameter to be detected, aging-adjusted, at an output 150 of sensor 100. Sensor characteristic curve 128 receives data, which correspond to the instantaneously detected sensor signals, from connection 130 via a connection 152. Based on characteristic curve 128, which has been aging-adjusted with the aid of aging information 124 and linkage 126, the operating parameter to be detected is output to output 150 via a further connection. The operating parameter which is output at output 150 is thus aging-adjusted. In one specific embodiment based hereon (not illustrated), the connection for transmitting the operating parameter is a multichannel connection. This multichannel connection may transmit, in addition to the operating parameter, i.e., the sensor signal, and the temperature, at least one additional variable or at least one additional state which is provided by the sensor.

In addition to aging information 124 which has been transmitted via connection 130, memory 122 may store further information, for example aging information, which is already present in sensor 100, such as the number of switch-on operations or the operating time. This aging information may likewise be stored in memory 122 as aging information 124, so that characteristic curve 128 according to this aging information is correctly provided, aging-adjusted, based on linkage 126. Control unit 140 is connected downstream from output 150 of sensor 100. The control unit may in particular be an engine control unit of an internal combustion engine which receives operating parameters from sensor 100 in aging-adjusted form. The interface between sensor 100 and control unit 140 corresponds to a conventional interface.

Sensor 100 and in particular temperature sensor 110 are in direct contact with an internal combustion engine (not illustrated), whose operating parameters are ascertained and regulated by control unit 140. Computing unit 120 may in particular be an ASIC or a microprocessor. The temperature which is detected by the sensor in particular is the intake air temperature of the internal combustion engine.

In one alternative specific embodiment, only aging information 124 is stored in computing unit 120. The aging information is read out by control unit 140. Based on the aging information, control unit 140 ascertains the state of the sensor, and in particular the characteristic curve which results from the aging. The control unit is also set up to compute the operating parameter of the internal combustion engine, aging-adjusted, according to the characteristic curve thus obtained.

What is claimed is:

1. A method for determining a state of a sensor configured to ascertain an operating parameter of an internal combustion engine, comprising:
operating the sensor to ascertain the operating parameter;
detecting, during operation of the sensor, at least one aging effect which has an influence on a sensor characteristic curve of the sensor, the sensor having different sensor characteristic curves for different states of the sensor;
storing, in an electronic memory, aging information which reflects the at least one aging effect; and
determining the state of the sensor from the stored aging information reflecting the aging effect which has acted on the sensor, based on a predefined relationship between the at least one aging effect and the state of the sensor.

2. The method as recited in claim 1, wherein:
the predefined relationship between the aging effect and the state of the sensor is present in one of the sensor or a control unit in the form of one of an approximation formula, a model, empirical data concerning sensor states as a function of aging effects, or a look-up table listing aging effects of different sensor states; and
the aging information stored in the memory is used to ascertain an associated state of the sensor linked to the aging information based on the predefined relationship.

3. The method as recited in claim 1, wherein one of:
a sensor characteristic curve which corresponds to the predefined relationship is stored in one of the sensor or a control unit; or
a characteristic curve correction is stored in one of the sensor or the control unit, the characteristic curve correction reflecting a difference between (i) a standard sensor characteristic curve of an unaged sensor and (ii) a sensor characteristic curve characterizing the sensor according to the stored aging information and the predefined relationship.

4. The method as recited in claim 3, wherein at least one sensor measured value is ascertained during operation of the sensor and converted into the operating parameter based on one of (i) the sensor characteristic curve or (ii) the standard sensor characteristic curve of the unaged sensor which is corrected by the characteristic curve correction.

5. The method as recited in claim 1, wherein the state of the sensor is determined by performing a statistical analysis the stored aging information, the result of the statistical analysis defining the state of the sensor.

6. The method as recited in claim 5, wherein the aging information is retrievably stored in electrical form in one of the sensor or a control unit.

7. The method as recited in claim 5, wherein the sensor is one of a flow rate sensor, a force sensor, a torque sensor, a pressure sensor, or an ultrasonic sensor.

8. The method as recited in claim 5, wherein one of:
(i) at least one of a number of switch-on operations of the sensor, an operating time of the sensor, a maximum operating temperature of the sensor, a temperature profile of the sensor, an operating time of the sensor above an upper temperature limit, an intensity of a vibration, and a duration of a vibration is detected as the aging effect by one of a detection device or an input/output interface; or
(ii) contamination of the sensor is detected as the aging effect based on an input via an input/output interface.

9. A sensor system for determining a state of a sensor configured to ascertain an operating parameter of an internal combustion engine, comprising:
a sensor having different sensor characteristic curves for different sensor states;
an electronic memory retrievably storing detected aging information which reflects at least one aging effect which has an influence on a sensor characteristic curve of the sensor;
a data transmission point connected to the electronic memory to facilitate retrievable storing of the aging information in the memory; and
an output configured to output the state of the sensor based on the stored aging information.

10. The sensor system as recited in claim 9, wherein one of:
(i) a predefined relationship between the aging effect and the state of the sensor is stored in the sensor in the form of one of an approximation formula, a model, empirical data concerning sensor states as a function of aging effects, or a look-up table listing aging effects of different sensor states, and the output is provided in the sensor; or
(ii) a predefined relationship between the aging effect and the state of the sensor is stored in a control unit connected to the sensor, in the form of one of an approximation formula, a model, empirical data concerning sensor states as a function of aging effects, or a look-up table listing aging effects of different sensor states, and the output is provided in the control unit.

11. The sensor system as recited in claim 9, wherein one of:
a sensor characteristic curve which corresponds to a predefined relationship between the aging effect and the state of the sensor is stored in one of the sensor or a control unit; or
a characteristic curve correction is stored in one of the sensor or the control unit, the characteristic curve correction reflecting a difference between (i) a standard sensor characteristic curve of an unaged sensor and (ii) a sensor characteristic curve characterizing the sensor according to the stored aging information and the predefined relationship.

12. The sensor system as recited in claim 10, wherein one of:
a sensor characteristic curve which corresponds to the predefined relationship is stored in one of the sensor or the control unit; or
a characteristic curve correction is stored in one of the sensor or the control unit, the characteristic curve correction reflecting a difference between (i) a standard sensor characteristic curve of an unaged sensor and (ii) a sensor characteristic curve characterizing the sensor according to the stored aging information and the predefined relationship.
